(19) United States
(12) Patent Application Publication
(10) Pub. No.: US 2025/0343256 A1
(43) Pub. Date: Nov. 6, 2025

(54) DEVICE AND METHOD FOR Z-SHAPED FEEDING OF A SEPARATOR WEB TO A STACKING PROCESS WITH WEB TENSION CONTROL

(71) Applicant: GROB-WERKE GmbH & Co. KG, MINDELHEIM (DE)

(72) Inventors: Karl MICHL, ERKHEIM (DE); Johannes HERB, BUCHLOE (DE); Tim JANUSCH, ERKHEIM (DE)

(21) Appl. No.: 19/195,984

(22) Filed: May 1, 2025

(30) Foreign Application Priority Data
May 2, 2024 (EP) 24173932.5

(51) Int. Cl. H01M 10/04

(52) U.S. Cl. CPC H01M 10/0404; H01M 10/0431

(57) ABSTRACT

Feeding a separator to a Z-folding process at the manufacture of battery cells, in which the separator is fed by: feeding a separator web with a first web tension to a web tension transmission unit which divides the web run of the separator web into sections with different web tensions; guiding the separator web from the web tension transmission unit with a second web tension to a separator guide unit; supplying the separator web in a Z-shape with a reciprocating movement of the separator guide unit in order to stack the battery cell; and controlling the second web tension depending on the position of the separator guide unit. In addition, apparatus, devices, controls, and computer programs for performing the feeding.

### CROSS-REFERENCES TO RELATED APPLICATIONS

This application claims the benefit of European Patent Application Number 24 173 932.5 filed on May 2, 2024, the entire disclosure of which is incorporated herein by way of reference.

### FIELD OF THE INVENTION

The invention relates to a separator web feed device for a battery cell manufacturing device for manufacturing battery cells by means of Z-folding, wherein the separator web feed device is configured to feed a separator web in a Z-shaped manner to a stacking device of the battery cell manufacturing device. Furthermore, the invention relates to a battery cell manufacturing device for manufacturing battery stacks by means of Z-folding, comprising a separator web feed device of this kind. The invention further relates to a separator web feeding method for Z-feeding a separator sheet to a Z-folding process in manufacturing a battery cell by Z-folding, and a battery cell manufacturing method using such a separator web feeding method. The invention also relates to a computer-implemented control unit and a computer program having instructions for carrying out such methods.

### BACKGROUND OF THE INVENTION

Concerning the technological background, reference is made to the following literature:
[1] EP 3 858 771 A1
[2] EP 4 258 402 A1
[3] WO 2023/072343 A1
[4] EP 2 770 569 A2
[5] DE 10 2018 200 958 A1
[6] US 2012/0110836 A1

Methods and devices for manufacturing battery cells by means of Z-folding are known from literature [1] to [6]. In particular the battery cell manufacturing device for manufacturing battery cells by means of Z-folding known from [3] comprises a stacking device and a separator web feed device for Z-feeding a separator web to the stacking device, wherein the separator web feed device has a separator web supply device and a separator web guide unit, wherein the separator web supply device for supplying the separator web is designed as the separator guide unit and wherein the separator guide unit can be moved back and forth to perform Z-folding.

The so-called Z-folding, as known from [2] to [6], for example, is a main process for battery cell assembly. In this process, anodes and cathodes are alternately stacked on top of each other. A separator separates the respective anodes and cathodes from each other and runs through the stack like a Z. This is how the name Z-folding for this variant of battery cell production comes about. A web run is responsible for providing the separator material and is essential for this. The respective users of such devices and processes have a wide range of requirements when it comes to the quality of the battery cell. Special requirements for the quality of the separator include, among other things, the avoidance of damage in general (e.g. caused by local overloading), the avoidance of unwanted wrinkling or the retention of the specified overhang to the electrodes (anode, cathode). Therefore, the web run and the material properties of the separators represent a challenge when it comes to inserting the separator into the stack in the desired quality, but also in the right cycle time.

Every currently known processing system for battery cell production using Z-fold technology has a separator web guide as an important part of the overall system. Using the example of the separator web guide known from [3], some challenges are explained below. For example, the separator guide unit is permanently coupled to the stacking movers of the electrodes, which, on the one hand, leads to greater dynamics within the web run and, on the other hand, prevents decoupling of the systems in order to generate an idealized displacement profile between the separator guide unit (improved cycle time distribution between the sub-processes).

A method for controlling a web tension during the production of battery cells is known from document [1]. However, document [1] has no relation to Z-folding. The cyclically strongly fluctuating web length changes that occur in the Z-folding process place increased demands on integrated dancer units to compensate for such web length changes. Although document [1] discloses improved control algorithms through cascaded force control, these do not represent a satisfactory technical solution for Z-folding that meets the requirements. A reaction would always require a detected control deviation, which is clearly too slow for the average controller clock rate of 4 ms and bandwidths in the range of 100 Hz for the 0.35 seconds or less sheet-to-sheet time targeted for the implementation of the invention. Although the intrinsic damping of the system introduced at the internal speed control increases the robustness and bandwidth of the dancer control, it would be exactly counterproductive due to the low aggressiveness of the interference suppression due to the required dynamics.

The invention is based on the problem of providing devices, apparatus and/or methods that can be used to improve the feeding of a separator web for Z-folding into a battery stack, particularly in terms of quality and/or cycle time.

### SUMMARY OF THE INVENTION

To solve this problem, the invention provides a separator web feed device according to various embodiments and a separator web feeding method according to various embodiments. Methods and devices for battery cell production by means of Z-folding using the separator web feed device or the separator web feeding method, as well as a control system designed for implementation and a computer program with instructions for this, are also disclosed in various embodiments.

The invention, according to a first aspect, provides a separator web feed device for a battery cell manufacturing device for manufacturing battery cells by means of Z-folding,
wherein the separator web feed device is designed to feed a separator web in a Z-shaped manner to a stacking device of the battery cell manufacturing device and comprises a separator web supply device, a web tension transmission unit, a position-controlled web tension control unit and a separator guide unit,
wherein the separator web supply device is designed to supply the separator web to the web tension transmission unit,
wherein the separator web is guided via the web tension transmission unit to the separator guide unit,
wherein the web tension transmission unit is designed to divide the web run of the separator web in the separator web supply device into sections with different web tensions in such a way that that the separator web has a first web tension in a first section located before the web tension transmission unit in the direction of movement and has a second web tension in a second section located after the web tension transmission unit in the direction of movement,
wherein the separator guide unit can be reciprocated for performing the Z-folding and wherein the position-controlled web tension control unit is configured to control the second web tension in dependence on the position of the separator guide unit.

In some embodiments, it is provided that the separator web supply device comprises a separator web unwinder adapted to unwind the separator web from a separator web supply roll at a predetermined constant or varying web speed for the Z-folding process.

In some embodiments, the separator web supply device comprises a first dancer unit for adjusting and/or controlling the first web tension to a constant predetermined value.

In some embodiments, the separator web supply device comprises a web run corrector unit arranged to counteract an off-center web run of the separator web.

In some embodiments, the web tension transmission unit is adapted to divide the web run into two web tension sections having different web tensions, wherein the first web tension which is present upstream of the web tension transmission unit with respect to the direction of movement of the separator web, is greater than the second web tension downstream of the web tension transmission unit with respect to the direction of movement.

The web tension transmission unit is preferably designed to divide the web run of the separator web into at least two different web tension regions in order to simultaneously counteract a strong sagging of the separator (region with higher web tension) and to keep the overall load on the separator, including web tension impulses, on the stack that has already been built up or is being built up (region with reduced web tension) low.

Preferred configurations of the web tension transmission unit have at least one drive unit, wherein the drive unit has a driven roller, which is referred to as a feed roller or drive roller, for example, and two non-driven deflection rollers. The driven roller is wrapped by the separator web at a predetermined wrap angle that can be adjusted in particular by means of the two non-driven deflection rollers.

This allows a substantially homogeneous pressure distribution to be generated on the separator web in order to change the web tension acting on the separator web. Thus, with such a web tension transmission unit, an inhomogeneous pressure distribution on the separator web can be prevented, as it is generated, for example, by a clamping unit with two rollers pressed against each other, between which the separator web is passed. Theoretically, such a clamping unit exerts a line load on the separator passing between the rollers. However, studies have shown that clamping does in fact exist only in the outermost regions of the separator web, for which reason an inhomogeneous pressure distribution occurs.

In some embodiments, the driven roller and the two deflection rollers of a drive unit are arranged alternately with respect to the direction of movement of the separator web.

According to one embodiment, the two deflection rollers are offset, i.e. off-center, relative to the driven roller.

In this context, “offset” means that the centers of the rollers are not on a straight line, or the rollers are arranged in different planes. In particular, the two deflection rollers are arranged in the same plane, and the driven roller is arranged in a plane parallel to it.

In some embodiments, the web tension transmission unit influences or changes the web tension according to the following equation (1):

$$\frac{{F}_{i n}}{{F}_{o u t}} < {e}^{n * μ * α}$$

where
Fᵢₙ=force from which the first web tension results;
Fₒᵤₜ=force from which the second web tension results;
n=number of drive units;
μ=coefficient of friction between driven roller and separator web; and
α=wrap angle of the separator web around the driven roller.

This means that a ratio of the forces for the first web tension and the second web tension and thus a ratio of the first and the second web tension is given by the number of drive units included in the web tension transmission unit, the coefficient of friction between the driven roller(s) and the separator web as well as the wrap angle of the separator web around the respective driven roll. The friction value between the driven roller and the separator web can be adjusted, for example, by coatings on the driven roller.

According to one embodiment, the wrap angle is adjustable via the positions of the deflection rollers relative to the driven roller.

In some embodiments, the position-controlled web tension control unit has a position-controlled dancer unit for controlling the second web tension depending on the position of the separator guide unit. In particular, the position of the dancer unit is selected such that the second web tension remains essentially constant regardless of the position of the separator guide unit. However, it is also possible to select the position of the dancer unit such that the second web tension has a predetermined value. In other words, it can be said that the position of the dancer unit is dependent on the position of the separator guide unit and is selected such that the second web tension has a predetermined value for each position of the separator guide unit and, in particular, is kept essentially constant.

In some embodiments, the position-controlled web tension control unit has a micro-compensation unit for compensating for web tension fluctuations occurring during the control of the second web tension, in particular due to modeling inaccuracies, such as manufacturing tolerances and/or control tolerances. Thus, the fine compensation unit enables even finer control of the second web tension and can thus further improve the ability of the second web tension to remain constant.

In some embodiments, the position-controlled web tension control unit has a computer unit with a memory in which a predetermined relationship between the position of the separator guide unit and a) the value of the second web tension and/or b) a position of a tension setting element is stored. Different tension setting elements can be provided that influence the tension of the separator web in the second web tension section. In particular, a dancer element is provided as the tension-adjusting element, and more particularly the micro-compensation unit.

In some embodiments, the position-controlled web tension control unit is designed to pre-control the second web tension. The positional relationship between the dancer unit, in particular the dancer axis, and the separator guide unit can be calculated in advance. The control of the second web tension via the position-controlled web tension control unit, also referred to as pre-control, is then based on this calculation. Furthermore, it is also conceivable to determine the web tension in real time, in particular to calculate it, and based on this, to control the position-controlled web tension control unit, in particular the fine compensation unit, accordingly so that the second web tension is kept essentially constant.

In some embodiments, the position-controlled web tension control unit has, as a tension adjustment element, a deflection roller mounted on an arm or bearing shield at a radial distance from a shaft, and a position-controlled motor for rotating the shaft and for pivoting the cantilever or the end shield. The tension adjustment element is, in particular, the position-controlled dancer unit.

In some embodiments, the separator web feed device has a separator guide device which has the separator guide unit and a movement mechanism for controlled movement of the separator guide unit.

In some embodiments, the separator guide unit is provided with a first and a second guide roller for guiding the separator web therebetween, and the movement mechanism is designed for controlled joint movement of the first and second guide rollers in a direction transverse to their central axes.

In some embodiments, the movement mechanism comprises a first movement unit for moving a first region of the separator guide unit engaging a first edge region of the separator web and a second movement unit for moving a second region of the separator guide unit engaging a second edge region of the separator web, and is designed to move the first and second movement units synchronously or so as to be leading or trailing relative to each other.

According to a further aspect, the invention provides a battery cell manufacturing device for manufacturing battery stacks by means of Z-folding, comprising a separator web feed device according to one of the above configurations and a stacking device for alternately stacking first and second electrodes with a Z-shaped separator web inserted therebetween.

It is preferred that the stacking device comprises a lowerable stacking table which is designed to always allow the same deposition height of the respective electrode fed and the separator inserted therebetween by lowering. The lowerable stacking table allows the upper edge of the stack to always remain in the same position. This allows a constantly repeating travel profile to be imposed over the entire stacking process.

According to a further aspect, the invention provides a separator web feed method for feeding a separator web in a Z-shape to a Z-folding process in the manufacture of a battery cell by means of Z-folding, comprising
a) feeding a separator web with a first web tension to a web tension transmission unit which divides the web run of the separator web into sections with different web tensions;
b) guiding the separator web from the web tension transmission unit with a second web tension to a separator guide unit;
c) supplying the separator web in a Z-shape by means of a reciprocating movement of the separator guide unit in order to stack the battery cell; and
d) controlling the second web tension depending on the position of the separator guide unit.

In some embodiments, step a) comprises the step:
a1) unwinding the separator web from a supply roll at a predetermined or constant or varying web speed.

In some embodiments, step a) comprises the step:
a2) controlling or regulating the first web tension to a predetermined value.

In some embodiments, step a) comprises the step:
a3) setting the first web tension to a value that is higher than the second web tension.

In some embodiments, step a) comprises the step:
a4) adjusting the first web tension by means of a first dancer unit.

In some embodiments, step a) comprises the step:
a5) adjusting or correcting the position of the separator web to be fed transversely to its direction of movement.

In some embodiments, step a) comprises the step:
a6) detecting the position of an edge of the separator web, correcting the position of the separator web to be fed depending on the detected position by means of angle adjustment of one or more guide rollers via which the separator web is fed.

In some embodiments, step b) comprises the step:
b1) adjusting a ratio between the first and the second web tension by means of friction on at least one drive unit of the web tension transmission unit and by means of adjusting a wrap angle of the separator web around the driven roller of the at least one drive unit.

In this case, the friction is determined in particular by the coefficient of friction between the driven roller and the separator web. This means that the coefficient of friction can be determined by the material pairing “driven roller-separator web.”

In some embodiments, step b) comprises the step:
b2) driving the driven roller of the at least one drive unit of the web tension transmission unit without slippage.

In some embodiments, step b) comprises the step:
b3) guiding the separator web successively around or through several drive units.

In some embodiments, step c) comprises the step:
c1) guiding the separator web between a pair of rollers of the separator guide unit that can be moved back and forth jointly.

In some embodiments, step c) comprises the step:
c2) moving the separator guide unit according to a predetermined movement pattern.

In some embodiments, step c) comprises the step:
c3) feeding the separator web to a battery cell stack always at the same height, wherein the battery cell stack is tracked vertically accordingly.

In other words, it can be said that the separator web is always fed to the battery cell stack at the same height, regardless of the stack height of the battery cell stack. This means that the battery cell stack is vertically tracked step by step, in particular layer by layer, during the build, e.g., by gradually moving the stacking table vertically downwards, always to the extent that the separator web is always fed to the battery cell stack at the same height. In particular, this also ensures that the relative position between the separator web feed and the top of the battery stack (during the build) remains essentially unchanged.

In some embodiments, step c) comprises the step:
c4) moving a first region of the separator guide unit engaging a first edge region of the separator web and moving a second region of the separator guide unit engaging a second edge region of the separator web such that the first and second regions are moved synchronously or relative to each so as to be leading or trailing.

In some embodiments, step d) comprises the step:
d1) determining a relationship or curve between the position of the separator guide unit and the value of the second web tension by means of simulation.

In some embodiments, step d) comprises the step:
d2) determining a relationship or curve between the position of the separator guide unit and the position or setting of a tension adjustment element by means of simulation.

In some embodiments, step d) comprises the step:
d3) predetermining a relationship or curve between the position of the separator guide unit and the value of the second web tension and/or the position of a tension adjustment element, and controlling the second web tension in accordance with the predetermined relationship or curve corresponding to the current position of the separator guide unit.

In some embodiments, step d) comprises the step:
d4) determining a relationship or curve between the position of the separator guide unit and the value of the second web tension and/or the position/setting of a tension adjustment element by comparison with a control that controls the second web tension to a desired value and comparison with the respective current position of the separator guide unit.

In some embodiments, step d) comprises the step:
d5) maintaining a constant predetermined second web tension at different positions of the separator guide unit.

In some embodiments, step d) comprises the step:
d6) position-dependent control of the second web tension by means of a position-controlled dancer unit.

In some embodiments, step d) comprises the step:
d7) moving a dancer unit depending on the position of the separator guide unit, in particular in such a way that the second web tension is maintained at a predetermined, preferably constant value.

In some embodiments, step d) comprises the step:
d8) providing a deflection roller rotatably mounted at a radial distance from a center and adjusting the angular position of the axis of rotation of the deflection roller relative to the center depending on the position of the separator guide unit.

In some embodiments, step d) comprises the step:
d9) compensating for web tension fluctuations occurring during control of the second web tension.

According to a further aspect, the invention provides a control device for a separator web feed device or battery cell manufacturing device according to one of the preceding embodiments, wherein the control device is designed to control the separator web feed device to carry out the method according to one of the preceding embodiments relating to the method.

According to a further aspect, the invention provides a computer program containing instructions that cause a device or apparatus according to one of the preceding embodiments to carry out the method according to one of the preceding embodiments.

Embodiments of the invention relate to devices, apparatus, and methods for use in the manufacture of battery cells by means of Z-folding.

Particularly preferred embodiments of the devices, apparatus, methods, controls, and computer programs according to the invention are aimed at avoiding or at least reducing one, several, or all of the following disadvantages:

Currently known arrangements of the web run of the separator web do not produce a homogeneous web tension. This results in web tension peaks, which lead to undesirable effects in the stacking process, such as separator penetration and/or creasing and/or, in particular as a result thereof, dendrite formation and/or short circuits.

The web tension peaks generate mechanical stress in the form of tensile forces that cause the separator to run in a misaligned manner. In order to counteract the separator running somewhat misaligned, the solutions currently in use employ hold-down fingers or similar devices to hold down the cell stack with a higher mechanical force. The surface pressure on the electrodes thus increases.

The surface pressure, in particular the increased surface pressure, can cause imprints on the electrodes which can lead to a change in structure that is visible under a microscope and may result in the electrode being declared “not in order”.

In particular, the undesirable web tension peaks and generally high web tension in previous solutions cause the separator to be pulled with high force around the hold-down fingers or similar devices. This leads to visible damage to the separator. The high web tension also damages the separator when the fingers or similar devices are pulled out during the process.

Due to the mechanical web guidance during the actual Z-folding process, separator material must be conveyed back into the web run, oppositely to the unwinding direction, in previous solutions. This is due to the unfavorable separator guidance resulting from the Z-fold pattern. This creates an additional variable within the web run system, which has a negative effect on the dynamics of the separator web, especially with regard to web tension.

Current solutions do not allow material properties such as the expansion behavior of the separator to be taken into account. This means that the web run cannot be monitored with high precision throughout the entire system, as an uncertain amount of separator is always released in the process due to the stretches that occur.

Undesirable and, in particular, often unpredictable web tension jumps in previous solutions also lead to certain elastic and plastic deformations of the separator, resulting in undesirable mechanical inhomogeneities in the structure of the separator material, which in turn influence the quality of the manufactured battery cell, e.g., with regard to Hi-Pot behavior→OK/NOK stack, power density, aging, etc.

Particularly preferred embodiments of the devices, apparatus, methods, control systems, and computer programs according to the invention offer at least one, several, or all of the following advantages:

Track tension jumps are significantly reduced and in particular even minimized with a new web run concept.

Misalignment, i.e., displacement of the separator from its target position along the length of the battery cell stack, is drastically reduced.

Stress on the hold-down axes, i.e., the hold-down fingers, is reduced. The reduction in stress also means that the filigree hold-down fingers are subjected to less strain.

With the new web run concept, significantly shorter cycle times, especially so-called “sheet to sheet” times, can be achieved, in particular from about 0.4 s to about 0.2 s, and more specifically from about 0.35 s to about 0.25 s.

In particular, the position-dependent web tension control unit significantly reduces the amount of returned separator and limits it to a small area of the system within the entire web run system. This simplifies the high-performance, i.e., very complex, design of the corresponding subsystems, which results in a significant reduction in the dynamics of the web run.

The material properties of the separator can be taken into account.

Some embodiments of the invention enable the achievement of a homogeneous separator web run, i.e., a separator web run with few or no unwanted web tension peaks or web tension fluctuations, which in turn results in a high-quality battery cell stack as the end product.

Some embodiments of the invention enable significantly shorter cycle times than solutions currently available on the market.

In order to take into account the various influencing parameters, such as the inertia and friction pair values of the individual deflection rollers, material properties, and material behavior of the separator, a theoretical analysis in the form of a web run simulation of the complete system was first carried out to achieve particularly preferred embodiments of the devices, apparatus, and methods according to the invention. Simulation results have been incorporated in particular into control sequences and the corresponding software.

In some designs of the invention, certain movement profiles of dancers/axes are determined by means of a web run simulation and the special structure or approach of the web run, which compensate for the dynamics on the separator during the Z-folding process.

In the simulation, the overall system with its arrangement of the various components plays a certain role. In particularly preferred embodiments, each individual assembly has a specific task that, when combined, results in an ideal web run concept.

For example, the commercially available simulation program “MapleSim” can be used to simulate the composition of the ideal overall system and to examine and verify the respective results before they are implemented in reality.

Particularly preferred designs of the invention have a driven, position-controlled dancer system in the second web tension section, for which a reciprocal movement profile is determined. This system compensates for the separator that is released, compensates for expansion behavior due to the material properties (modulus of elasticity), releases material as required, and thus removes all dynamics from the system.

The unwanted dynamics in the web run are generated by a continuously running unwinder and a separator guide unit that moves back and forth to deposit the separator in a Z-fold pattern and thus moves regularly in the opposite direction to the unwinding direction of the unwinder, whereby a certain length of the separator becomes free at least temporarily, i.e., “hangs” loosely, essentially without web tension in the overall system.

In some embodiments, an ultra-fine compensation unit is provided to additionally compensate for fluctuations that occur between simulation and reality.

In preferred embodiments, a web tension translation unit based on Euler-Eytelwein's rope friction law divides the entire separator strand into (at least) two areas with different web tensions.

Some further advantages of particularly preferred embodiments of the invention are:

Web tension peaks are reduced, in particular reduced to a minimum, by means of a new web run concept, and the web tension acting on the separator web is thus homogenized.

A homogeneously adjusting web tension reduces misalignment of the separator web along the battery cell stack to be formed, thereby increasing the quality of the battery stack.

The hold-down force required to fix the cell stack by means of the hold-down axes, i.e. the hold-down fingers, is reduced.

The reduction in hold-down force means that the filigree hold-down fingers are subjected to less mechanical stress. This in turn has an impact on the material and design freedom of these fingers.

A new web run concept allows significantly shorter cycle times (sheet-to-sheet times) to be achieved without affecting the deposition quality of the separator. The shorter cycle times allow the number of machines to be reduced, which in turn reduces the decisive factor of footprint in large systems. The footprint, i.e., how many GWh can be produced on how much space, is a very high priority for battery manufacturers and is therefore a factor that should not be underestimated when selling the machines.

Due to the geometric arrangement, hardly any separator material needs to be returned to the web run during the stacking process, which leads to a significant reduction in dynamics and smoother separator web running.

Homogeneous web tension, lower hold-down forces, and the resulting reduction in surface pressure significantly counteract the risk of mechanical damage to the battery cell, especially to the electrodes held down by the hold-down fingers.

The load on the separator when it is folded around the hold-down fingers and when the hold-down fingers are pulled out during the process, also benefits the low and homogenized web tension. The risk of undesired cell damage is reduced.

### BRIEF DESCRIPTION OF THE DRAWINGS

Embodiments are described in more detail below with reference to the accompanying drawings.

FIG. 1 shows an overview representation of an embodiment of a battery cell manufacturing device with stacking device and separator web feed device in a view seen from the side;

FIG. 2 shows a schematic diagram which explains an operating principle of a web tension transmission unit of the separator web feed device of the battery cell manufacturing device of FIG. 1;

FIG. 3 shows a perspective view of an exemplary configuration of the web tension transmission unit;

FIG. 4 shows a perspective view of an exemplary configuration of a position-controlled web tension control unit of the separator web feed device of the battery cell manufacturing device of FIG. 1;

FIG. 5 shows a perspective view of an exemplary configuration of a separator guide unit of the separator web feed device of the battery cell manufacturing device of FIG. 1;

FIG. 6 shows a perspective view of an exemplary configuration of a stacking table of the stacking device of the battery cell manufacturing device of FIG. 1; and

FIG. 7 shows a schematic representation of a simulation sequence for carrying out a two-stage simulation to obtain a movement curve for a tension adjustment element of the position-controlled web tension control unit.

### DETAILED DESCRIPTION OF THE PREFERRED EMBODIMENTS

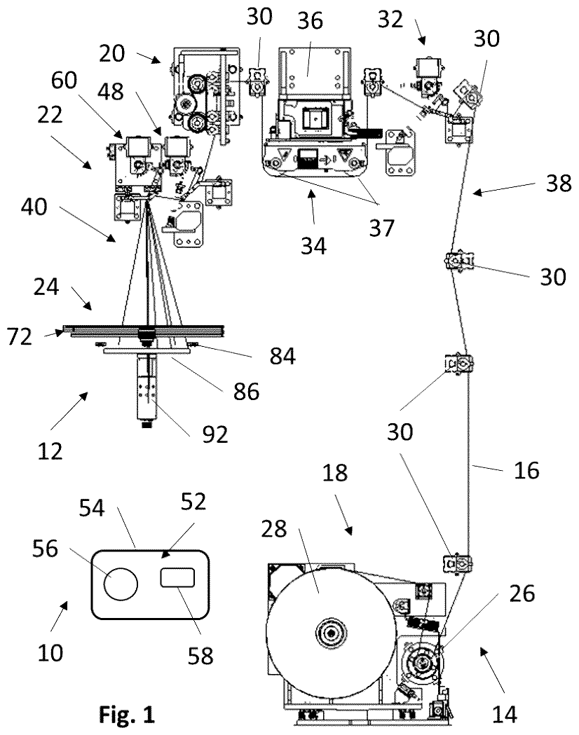

FIG. 1 shows an overview of a preferred embodiment of a battery cell manufacturing device 10 for manufacturing battery stacks by means of Z-folding. The battery cell manufacturing device 10 has a stacking device 12 for alternately stacking first and second electrodes with a separator web 16 inserted between them in a Z-shape, and a separator web feed device 14 for feeding a separator web 16 to the stacking device 12 in a Z-shape.

The separator web feed device 14 has a separator web supply device 18, a web tension transmission unit 20, a position-controlled web tension control unit 22 and a separator guide unit 24.

The separator web supply device 18 is designed to supply the separator web 16 to the web tension transmission unit 20.

In the embodiment shown, the separator web supply device 18 has an unwinder 26, which unwinds the separator web 16 from a separator web supply roll 28. The unwinder 26 unwinds the separator material required for the Z-folding process at a predetermined, in particular constant, web speed. This speed varies depending on the desired cycle time and the cell format to be processed.

The separator web 16 is guided to the web tension transmission unit 20, for example via deflection units 30, such as deflection rollers and a first web tension control unit, which is designed, for example, as a first dancer unit 32.

In some embodiments, the first dancer unit 32 ensures a constant (first) web tension between the unwinder 26 and the web tension transmission unit 20. For example, by using a pneumatically controlling valve, web tension fluctuations (caused by various factors, such as eccentricities of the unwinder, manufacturing tolerances, etc.) can be compensated flexibly and in the shortest possible time and controlled to the desired value.

In the web run of the separator web 16, a web run correction unit 34 is also provided in the embodiment shown, which is set up to counteract an eccentric run of the separator web 16. In the embodiment shown, this web run correction unit 34 has a rotating frame 36. The web run correction unit 34 is provided, for example, upstream of the web tension transmission unit 20 and downstream of the first dancer unit 32 with respect to the direction of movement of the separator web 16, but can also be provided at another point in the web run.

The web run correction unit 34 counteracts an off-center run of the separator by detecting the edge of the web. This is done, for example, by an arrangement of rollers, such as a pair of rollers 37, slightly inclined relative to the web. In the embodiment shown, the pair of rollers 37 is mounted in the rotating frame 36, which can rotate about an axis. The slightly inclined arrangement takes place, for example, via the control of an electric cylinder.

The separator web 16 is guided to the separator guide unit 24 via the web tension transmission unit 20. The web tension transmission unit 20 is designed to divide the run of the separator web 16 in the separator web feed device 14 into sections 38, 40 with different web tensions. The separator web 16 has a first web tension in a first section 38 upstream of the web tension transmission unit 20 in the direction of movement, which is controlled by the first web tension control unit—here, for example, the first dancer unit 32—and in particular is kept constant or homogeneous. In a second section 40 located after the web tension transmission unit 20 in the direction of movement, the separator web 16 has a second web tension.

The separator guide unit 24 can be moved back and forth to perform the Z-folding. The position-controlled web tension control unit 22 is arranged to control the second web tension depending on the position of the separator guide unit 24. In other words, it can be said that the position-controlled web tension control unit 22 is controlled in dependence on the position of the separator guide unit 24 to maintain the second web tension at a predetermined value, wherein the predetermined value is in particular substantially constant. It can therefore also be said that the position-controlled web tension control unit 22 serves to compensate for the position of the separator guide unit 24 in the separator web run in such a way that the second web tension is set to the predetermined value.

In the following, an embodiment of the web tension transmission unit 20 is explained in more detail with reference to the illustration in FIGS. 1, 2 and 3. The web tension transmission unit 20 makes it possible to divide the web run into two different web tension sections 38, 40. A higher web tension-first web tension—is required upstream of this web tension transmission unit 20 due to the greater distances between the deflection rollers—deflection units 30. Too low a tension in the separator web 16 causes the separator to sag and makes it easier for the separator web 16 to run undesirably, especially in the first web tension section 38. After the web tension transmission unit 20, a significantly lower web tension—second web tension—is desirable, since such a tension has emerged as a positive parameter for the stacking and Z-folding process and has certain advantages. These advantages have already been listed in more detail above.

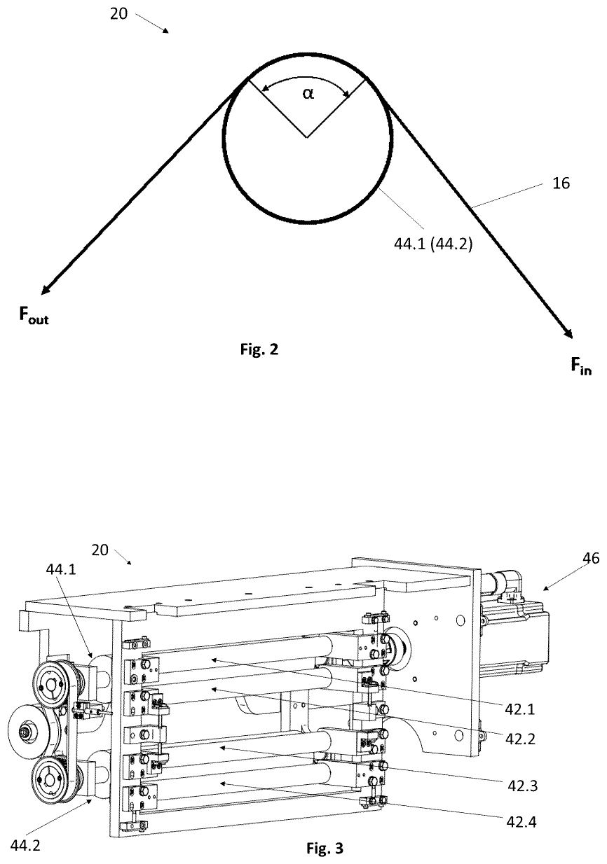

The physical concept on which preferred designs of this web tension transmission unit 20 are based is based on rope friction, which is described by the Euler-Eytelwein law of rope friction according to the following equations with reference to FIG. 2:

$$\begin{matrix}In ( {F}_{i n} / {F}_{o u t} ) = α \times μ & for {F}_{i n} > {F}_{o u t} \\ {F}_{o u t} \times {e}^{α \times μ} = {F}_{i n} & \end{matrix}$$

As can be seen from the equations, only the wrap angle α of the rolls/rollers and the friction coefficient μ between the rope, in this case the separator, and the roller shell surface, which may have a roller coating in particular, have an influence on the transmission ratio Fᵢₙ to Fₒᵤₜ. A slip analysis can be used to check whether the desired transmission ratio of the two different web tensions can be implemented. In this case, driven rollers—drive rollers 44.1, 44.2—of the web tension transmission unit 20, which are driven at the same web running speed as the unwinder 26, should be slip-free, as any slip that occurs could cause problems, such as increased web tension peaks due to incorrect interpolation between the controlled dancer unit and the separator guide unit 24.

FIG. 3 shows an exemplary structure of an embodiment of the web tension transmission unit 20. The web tension transmission unit 20 according to FIG. 3 has, by way of example, two drive units 41, each comprising a driven roller or drive rollers 44.1, 44.2 and two deflection rollers 42.1, 42.2, 42.3, 42.4. The drive rollers 44.1, 44.2 of the drive units 41 are driven by a motor 46. In other words, it can be said that the embodiment of the web tension transmission unit 20 shown in FIG. 3 comprises a first to fourth deflection roller 42.1-42.4, a plurality of drive rollers 44.1, 44.2 and a motor 46. The motor 46 is located at the rear or on one side, as viewed in the longitudinal direction of the rollers, and drives the two drive rollers 44.1, 44.2, which are coupled to one another here. The four deflection rollers 42.1-42.4 here provide the separator guidance and the necessary wrapping, with two deflection rollers 42.1-42.2 or 42.3-42.4 per drive unit 41 being assigned to one drive roller 44.1 or 44.2 respectively. The position of the two deflection rollers 42.1-42.2; 42.3-42.4 relative to the respective drive roller 44.1; 44.2 can be used to set the wrap angle α with which the separator is wrapped around the respective drive roller 44.1, 44.2. Depending on the wrap angle, the coefficient of friction and the transmission ratio to be set, this web tension transmission unit 20 can also be extended with a further (third) drive unit 41, comprising a drive roller and correspondingly two deflection rollers.

In the separator web feed device 14 shown in FIG. 1, the position-controlled web tension control unit 22 provided in the second section optionally has an ultra-fine compensation unit 48. In this embodiment, the ultra-fine compensation unit 48 is provided in the web run of the separator between the web tension transmission unit 20 and a position-controlled tension adjustment element 50 of the position-controlled web tension control unit 22. The ultra-fine compensation unit 48 is designed, for example, as a further dancer unit and is intended to cancel out any web fluctuations that occur which have not been compensated for by the subsequent position-controlled tension adjustment element 50. In the ideal case, which reflects the simulation, this ultra-fine compensation unit 48 should be completely fixed. However, deviations between the simulation and reality will cause it to fluctuate and make minute movements.

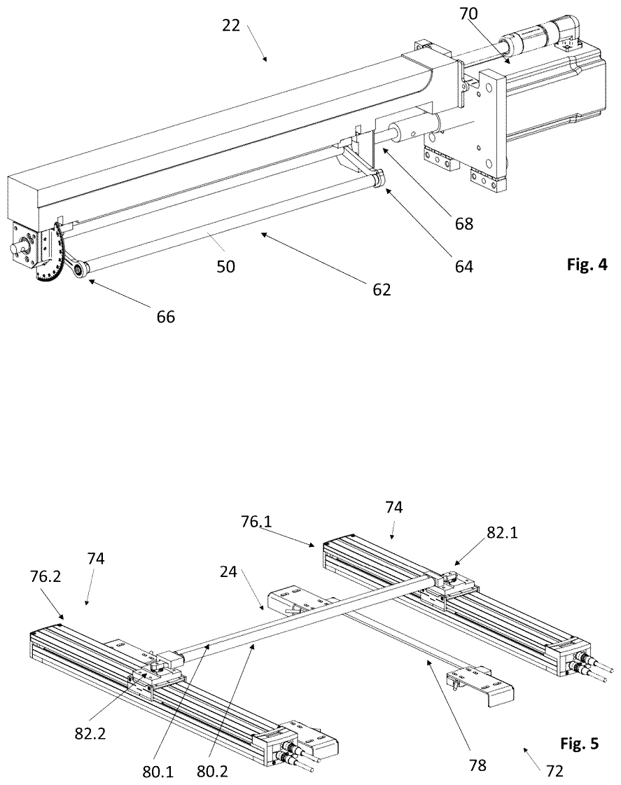

As shown in FIGS. 1 and 4, the position-controlled web tension control unit 22 has at least one tension adjustment element 50, which acts on the separator web 16 in such a way that it can influence and adjust its web tension. In some embodiments not shown, the tension adjustment element 50 can be mechanically coupled to the movement of the separator guide unit 24, for example via a control cam. In this case, the shape of the control cam can be determined beforehand by simulation processes similar to the type described below in order to determine a suitable relation of the movement or adjustment of the tension adjustment element 50 depending on the movement of the separator guide unit 24. In preferred embodiments, the position-controlled web tension control unit 22 includes a computer unit 52 having stored in its memory a predetermined relationship between the position of the separator guide unit 24 and the movement or position of the tension adjustment element 50. The computer unit 52 can be designed separately. In the embodiment shown, the computer unit 52 is designed as part of a control system 54 of the separator web feed device 14 or of the entire battery cell manufacturing device 10, for example as part of a computer program (control software). The controller 54 has a processor 56 and a memory 58. The controller 54 is in operative connection with the actuators, axes, movement mechanisms and movement units as well as sensors of the battery cell manufacturing device 10 and controls the battery cell manufacturing process as well as a method for feeding the separator, which will be explained in more detail below.

In preferred designs, the predetermined relationship or curve between the movement of the separator guide unit 24 and the movement of the tension adjustment element 50 is such that the dynamics introduced into the web run by the movement of the separator guide unit 24 are balanced as far as possible, i.e., the second web tension is as constant as possible. In some embodiments, however, it may also be advantageous to make adjustments to the second web tension during certain phases. In such designs, a predetermined relationship between the position of the separator guide unit 24 and the value of the second web tension may be stored in the computer unit 52.

In the embodiment shown, the position-controlled web tension control unit 22 has a position-controlled dancer unit 60. This can be designed differently. A preferred embodiment is shown in FIG. 4. For example, a deflection roller 62 is provided as the tension adjustment element 50. In some embodiments not shown, the deflection roller 62 can be moved linearly in order to increase or decrease the web run of the separator web 16 and thus control the second web tension. In the embodiment shown in FIG. 4, the deflection roller 62 is mounted on a cantilever 64 and/or end shield 66 at a radial distance from a shaft 68. Furthermore, a motor 70 controlled in position by the computer unit 52 is provided for rotating the shaft 68 and thus for pivoting the cantilever 64 and the end shield 66.

FIG. 4 shows the structure of the position-controlled dancer unit 60 with the position-controlled motor 70, deflection roller 62 and the end shields 66. The lightweight construction of the dancer unit 60 is particularly noteworthy here.

In the embodiment shown in FIG. 1, the position-controlled dancer unit 60 is provided for particularly advantageous adjustment of the second web tension. Acting on the separator guide unit 24 below it, the dancer of the position-controlled dancer unit 60 compensates for the resulting dynamics due to the Z-folding process. Since the unwinder 26 feeds separator into the system at a constant web speed and different quantities of separator are required at any time during the stacking process—which is also heavily dependent on the travel profile (cell format) and the cycle time of the separator guide unit—the ideal position curve is determined by means of simulation for the design of the battery cell manufacturing device 10. In particular, it is provided that this ideal position curve not only records the dynamics, but also sets the desired web tension through its travel profile.

Due to the short reaction times, feedforward control is used in some embodiments. (Force) control is not expedient here, as evaluating the web tension and processing and controlling a control variable takes too much time.

In the following, advantageous designs of the separator guide unit 24 are explained in more detail using the illustration in FIGS. 1 and 5. FIG. 5 shows an example for a separator guide device 72, which has the separator guide unit 24 that can be moved back and forth and a movement mechanism 74 for moving the separator guide unit 24 controlled by the controller 54. The movement mechanism 74 has a first movement unit 76.1 with a first axis (in the sense of an actuator) for moving a first region of the separator guide unit 24 engaging a first edge region of the separator web 16 and a second movement unit 76.2 with a second axis (in the sense of an actuator) for moving a second region of the separator guide unit 24 engaging a second edge region of the separator web 16.

The separator guide unit 24 has, for example, a first and a second guide roller 80.1, 80.2 for guiding the separator web 16 therebetween. The ends of the guide rollers 80.1, 80.2 are each mounted on swivel joints 82.1, 82.2, which can be moved transversely to the axes of rotation of the guide rollers 80.1, 80.2 by the axes—movement units 76.1, 76.2—which are equipped with linear motors, for example. In some embodiments, the movement mechanism 74 is designed for a controlled joint movement of the first and second guide rollers 80.1, 80.2 in the direction transverse to their central axes. In particular, the movement mechanism 74 is designed to move the first and second movement units 76.1, 76.2 synchronously or in a leading or trailing manner relative to one another.

Furthermore, a FinalCheck sensor 78 is shown in FIG. 5, with which the run of the separator web 16 can be finally checked during Z-folding.

In some embodiments of the separator guide unit 24, an independent NC-controlled axis—movement mechanism 74—drives the separator from left to right or right to left (based on the illustration in FIG. 1). This axis is responsible for the actual Z-folding movement and folding around hold-down fingers 84 of the stacking device 12. The separator guide unit 24 is arranged just above the upper edge of the stack, which in turn remains in the same position by lowering a stacking table 86 of the stacking device 12. In this way, a constantly cyclically repeating travel profile can be imposed over the entire stacking process.

By decoupling the guide of the separator from the stacking axes of the electrodes, this axis—movement mechanism 74—can move along any profile. It is advantageous here if a short stop is made, especially at the turnaround around the hold-down finger 84, as corresponding simulations have shown web tension jumps to be expected at this point.

FIG. 5 shows a more explicit exemplary structure of the separator guide device 72 with the separator guide unit 24 and its components. The first axis-first movement unit 76.1—and the second axis-second movement unit 76.2—are given a travel profile, whereby these can also be mutually leading or trailing due to the swivel joint 82.1, 82.2. In this way, a course of the separator web 16 can be counteracted by integrating the FinalCheck sensor 78 and generating a desired skew of the axes. The separator is guided between the two guide rollers 80.1, 80.2 mounted on the two axes.

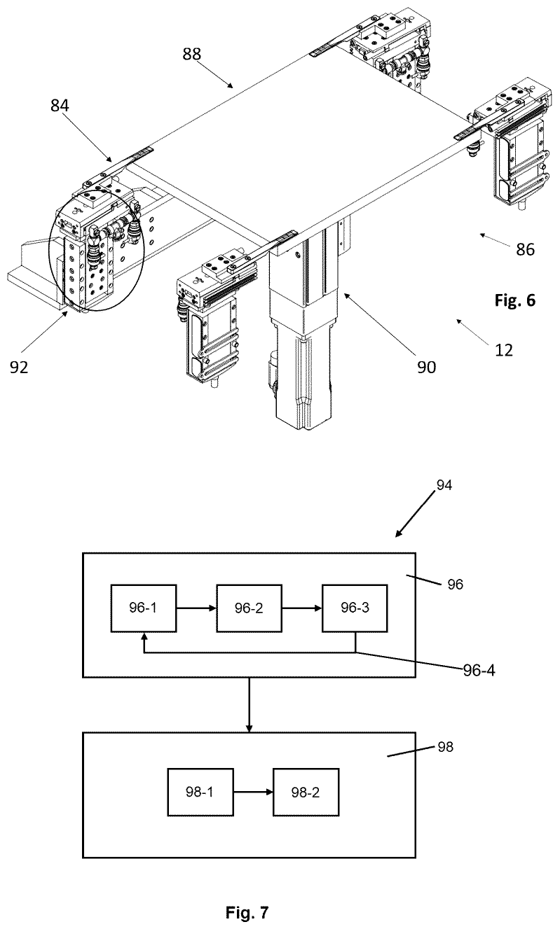

In the following, an exemplary structure of the stacking device 12 is explained in more detail with reference to the illustration in FIGS. 1 and 6. The stacking device 12 has the stacking table 86 with a stacking table top 88 and a first to fourth hold-down finger 84. The stacking table top 88 can be moved by means of a lowering axis 90—movement mechanism for raising and in particular lowering the stacking table top 88—in particular in order to always perform the current stacking at the same height. The hold-down fingers 84 can be moved up and down and back and forth with associated hold-down axes 92 (movement mechanism for the hold-down fingers).

Accordingly, in some embodiments, the stacking device 12 has a lowerable stacking table 86. By lowering the stacking table 86, it is always possible to achieve the same stacking height of the electrode and consequently of the separator. This means that the separator guide unit 24 always has the same travel profile relative to the stacking table 86 and the hold-down fingers 84. As a result, a constantly consistent cycle can be loaded.

FIG. 6 shows the exemplary design and implementation with a stacking table 86 that can be lowered in height, which enables the separator guide unit 24 and stacking table top 88 to always be placed at the same placement height and thus sets a constant value between the separator guide unit 24 and the stacking table top 88.

In order to determine an optimum relationship between the movement of the separator guide unit 24 and, depending on this, the movement of the tension adjustment element 50 of the position-controlled web tension control unit 22, a simulation is recommended in which the function of the separator web feed device 14 to be installed or set up is simulated.

In the following, an exemplary simulation sequence 94 is described with reference to FIG. 7, wherein FIG. 7 shows a schematic representation of such a simulation sequence 94. In such a simulation, the determination of the optimum curve for the position-controlled web tension control unit 22 is of particular interest. In particular, the determination of the pilot-controlled movement profile of the position-controlled dancer unit 60 is of importance for this.

In a first stage 96 of the simulation, a movement of a dancer unit 60a used to control the second web tension is first simulated with a force control (96-1). Here, the separator guide unit 24 is subjected to a certain movement profile. It can also be said that a position is specified for the separator guide unit 24, 96-2. At the end of the web run there is an evaluation unit which detects the web tension and compares it with the specified target value, 96-3. This information is fed back via a PID control loop 96-4 and a force which varies over time is applied to the (here force-controlled) dancer unit 60a. This sets the desired web tension. An evaluation unit in the pivot point of the dancer unit 60a records the course of the rotational position over time, which results from the ideally specified force profile of the PID control. Consequently, the angular position, i.e., the rotational position, over time is the result of the force control over time. In other words, it can be said that the angular position over time serves as the basis for the optimal curve for the position-controlled web tension control unit 22.

This position curve, which is determined to be ideal, is finally applied directly to the dancer in a second sister simulation 98. In this simulation, the replacement of the force-controlled dancer 60a with a position-controlled dancer unit 60 changes in particular. The ideal curve is read in via a table, 98-1, and applied to this dancer unit 60, 98-2. The PID control thus becomes superfluous and is omitted in this form of simulation.

The complete simulation is based solely on an offline determination of control parameters. Control within the machine is not feasible from the aspect of time due to the processing time of the actual value, feedback via PLC, evaluation and control of the manipulated variable at the desired cycle times. The duration of the processing creates too great a time delay, so that the manipulated variable would have to be recalculated by the time it is finally fed back. This would result in a constant offset, which would not lead to the desired web tension. As a result, a predefined position curve is determined and loaded in reality.

For verification and checking, this is simply imported into the simulation program and the result is checked purely by simulation.

For implementation in the machine, the position of the dancer unit 60 is not output as a function of time, but rather in relation to the position of the separator guide unit 24 in terms of control technology. The position of the separator guide unit 24 therefore acts as a master axis for the position-controlled dancer unit 60.

The separator guide unit 24 in turn has a further master, the so-called stack axis. This axis has the grippers (not shown), which in turn grip the electrode material, align it and finally place it on the stacking table. Possible gripper designs are known to the skilled person from the above-mentioned literature.

An ideal combination of these axis movements ultimately leads to a high-quality battery cell that is stacked in the shortest possible time.

In the intended use of the battery cell manufacturing device 10, a corresponding battery cell manufacturing process for manufacturing battery cells can be carried out by Z-folding, wherein a separator is fed as separator web 16.

It is desirable to fold the separator in a very short cycle time during Z-folding. To wrap the electrodes with the separator, the separator is advantageously moved across the electrode, then stops and moves back in the opposite direction. It is also desirable that the separator is first unwound by the separator guide unit 24 as it passes over the electrode and is then abruptly returned at the apex.

The following steps are therefore advantageously carried out to feed the separator web 16:
a) feeding the separator web 16 with a first web tension to the web tension transmission unit 20, which divides a web run of the separator web 16 into sections 38, 40 with different web tensions;
b) guiding the separator web 16 from the web tension transmission unit 20 with a second web tension to the separator guide unit 24;
c) Z-shaped feeding of the separator web 16 by means of reciprocating movement of the separator guide unit 24 for stacking the battery cell; and
d) controlling the second web tension depending on the position of the separator guide unit 24.

The web tension transmission unit 20 is advantageously used to set a significantly lower web tension that is predefined downstream of the web. In some embodiments, the ideal position profile (angular position) of the position-controlled dancer unit is determined in advance depending on the system or cell parameters and the associated axis dynamics of the separator guide unit 24, for example using MapleSim. This has been explained above with reference to the specific examples; it is clear to the skilled person that corresponding adjustments must be made in the simulation if the position-controlled web control unit 22 is designed differently.

In order to improve the feeding of a separator to a Z-folding process in battery cell production in terms of quality and cycle time, the separator is fed in the following steps:
a) feeding a separator web (16) with a first web tension to a web tension transmission unit (20), which divides a web run of the separator web into sections (38, 40) with different web tensions;
b) guiding the separator web (16) from the web tension transmission unit (20) with a second web tension to a separator guide unit (24);
c) Z-shaped feeding of the separator web (16) by means of a reciprocating movement of the separator guide unit (24) for stacking the battery cell; and
d) controlling the second web tension depending on the position of the separator guide unit (24).

Furthermore, apparatus (14), devices (10), controllers (54) and computer programs for performing the feeding are proposed.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

10 device
12 stacker
14 separator web feed device
16 separator web
18 separator web supply device
20 web tension transmission unit
22 position-controlled web tension control unit
24 separator guide unit
26 unwinder
28 separator web supply roll
30 deflection unit
32 first dancer unit
34 web run correction unit
36 rotating frame
37 pair of rollers
38 first section of web run
40 second section of web run
41 drive unit
42.1 first deflection roller
42.2 second deflection roller
42.3 third deflection roller
42.4 fourth deflection roller
44.1 first drive roller
44.2 second drive roller
46 motor
48 ultra-fine compensation unit
50 tension adjustment element
52 computer unit
54 controller
56 processor
58 memory
60 position-controlled dancer unit
60a force-controlled dancer unit (first simulation stage)
62 deflection roller (example for position-controlled tension adjustment element)
64 cantilever
66 end shield
68 shaft
70 motor
72 separator guide device
74 movement mechanism
76.1 first movement unit
76.2 second movement unit
78 FinalCheck sensor
80.1 first guide roller
80.2 second guide roller
82.1 first swivel joint
82.2 second swivel joint
84 hold-down finger
86 stacking table
88 stacking table top
90 lowering axis
92 hold-down axis
94 simulation
96 first stage of simulation
98 second stage of simulation

Claimed is:

1. A separator web feed device for a battery cell manufacturing device for manufacturing battery cells by Z-folding, wherein the separator web feed device is configured to feed a separator web in a Z-shaped manner to a stacking device of the battery cell manufacturing device and comprises:
a separator web supply device;
a web tension transmission unit;
a position-controlled web tension control unit; and
a separator guide unit,
wherein the separator web supply device is configured to supply the separator web to the web tension transmission unit,
wherein the separator web is guided via the web tension transmission unit to the separator guide unit,
wherein the web tension transmission unit is configured to divide a web run of the separator web in the separator web supply device into sections with different web tensions in such a way that that the separator web has a first web tension in a first section located before the web tension transmission unit in a direction of movement and has a second web tension in a second section located after the web tension transmission unit in the direction of movement,
wherein the separator guide unit is configured to be reciprocated for performing the Z-folding, and
wherein the position-controlled web tension control unit is configured to control the second web tension depending on a position of the separator guide unit.

2. The separator web feed device according to claim 1, further comprising at least one or more of the following units:
a first dancer unit for adjusting, or controlling, or adjusting and controlling the first web tension to a constant predetermined value; and
a web run correction unit configured to counteract an off-center run of the separator web.

3. The separator web feed device according to claim 1, wherein the first web tension is greater than the second web tension, or
wherein the web tension transmission unit has at least one drive unit and the at least one drive unit comprises a driven roller and two non-driven deflection rollers, or
both.

4. The separator web feed device according to claim 3, wherein the driven roller and the two deflection rollers of the at least one drive unit are arranged alternately with the respect to the direction of movement, or
wherein the two deflection rollers are offset relative to the driven roller, or
both.

5. The separator web feed device according to claim 3, wherein the web tension transmission unit influences the web tension according to the following equation:
$$\frac{{F}_{in}}{{F}_{out}} < {e}^{n * μ * α} , \qquad ( 1 )$$
where
Fᵢₙ=force from which the first web tension results;
Fₒᵤₜ=force from which the second web tension results;
n=number of drive units;
μ=coefficient of friction between driven roller and separator web; and
α=wrap angle of the separator web around the driven roller.

6. The separator web feed device according to claim 1, wherein the position-controlled web tension control unit comprises a position-controlled dancer unit for controlling the second web tension dependent on the position of the separator guide unit, or
wherein the position-controlled web tension control unit comprises an ultra-fine compensation unit for compensating for web tension fluctuations occurring during the control of the second web tension; or
wherein the position-controlled web tension control unit comprises a computer unit with a memory having stored therein a predetermined relationship between the position of the separator guide unit and a) a value of the second web tension, or b) a position of a tension adjustment element, or both a) and b); or
wherein the position-controlled web tension control unit is configured for feedforward control of the second web tension; or
wherein the position-controlled web tension control unit comprises a deflection roller which is mounted on a cantilever or end shield at a radial distance from a shaft, and a position-controlled motor for rotating the shaft and for pivoting the cantilever or the end shield; or
any combination of the foregoing.

7. The separator web feed device according to claim 1, further comprising:
a separator guide device which has the separator guide unit and a movement mechanism for controlled movement of the separator guide device,
wherein the separator guide unit has a first guide roller and a second guide roller for guiding the separator web therebetween and the movement mechanism is designed for a controlled joint movement of the first and second guide rollers in a direction transverse to central axes thereof, or
wherein the movement mechanism comprises a first movement unit for moving a first region of the separator guide unit engaging a first edge region of the separator web and a second movement unit for moving a second region of the separator guide unit engaging a second edge region of the separator web, and is configured to move the first and second movement units synchronously or so as to be leading or trailing relative to each other, or
both.

8. A battery cell manufacturing device for manufacturing battery stacks by Z-folding, comprising:
the separator web feed device according to claim 1, and
a stacking device for alternately stacking first and second electrodes with a Z-shaped separator web inserted therebetween.

9. A method for feeding a separator web in a Z-shape to a Z-folding process for manufacture of a battery cell by Z-folding, the method comprising:
a) feeding a separator web with a first web tension to a web tension transmission unit which divides a web run of the separator web into sections with different web tensions;
b) guiding the separator web from the web tension transmission unit with a second web tension to a separator guide unit;
c) supplying the separator web in a Z-shape with a reciprocating movement of the separator guide unit in order to stack the battery cell; and
d) controlling the second web tension depending on a position of the separator guide unit.

10. The method according to claim 9, wherein step a) comprises at least one or more of:
a1) unwinding the separator web from a supply roll at a predetermined or constant or varying web speed;
a2) controlling or regulating the first web tension to a predetermined value;
a3) setting the first web tension to a value that is higher than the second web tension;
a4) adjusting the first web tension with a first dancer unit;
a5) adjusting or correcting a position of the separator web to be fed transversely to a direction of movement; and,
a6) detecting a position of an edge of the separator web, correcting the position of the separator web to be fed depending on a detected position with an angle adjustment of one or more guide rollers via which the separator web is fed.

11. The method according to claim 9, wherein step b) comprises at least one or more of:
b1) adjusting a ratio between the first web tension and the second web tension with friction on at least one drive unit of the web tension transmission unit and with adjusting a wrap angle of the separator web around a driven roller of the at least one drive unit;
b2) driving a driven roller of the at least one drive unit of the web tension transmission unit without slippage; and,
b3) guiding the separator web successively around, through, or both several drive units.

12. The method according to claim 9, wherein step c) comprises at least one or more of:
c1) guiding the separator web between a pair of guide rollers that are configured to move back and forth jointly;
c2) moving the separator guide unit according to a predetermined movement pattern;
c3) feeding the separator web to a battery cell stack always at a height that does not change, wherein the battery cell stack is tracked vertically accordingly; and,
c4) moving a first region of the separator guide unit engaging a first edge region of the separator web and moving a second region of the separator guide unit engaging a second edge region of the separator web such that the first and second regions are moved synchronously or relative to each other so as to be leading or trailing.

13. The method according to claim 9, wherein step d) comprises at least one or more of:
d1) determining a relationship or curve between a position of the separator guide unit and a value of the second web tension with simulation;
d2) determining a relationship or curve between a position of the separator guide unit and a position or setting of a tension adjustment element with simulation;
d3) predetermining a relationship or curve between a position of the separator guide unit and a value of the second web tension, or a position or setting of a tension adjustment element, or both and controlling the second web tension in accordance with the predetermined relationship or curve corresponding to a current position of the separator guide unit;
d4) determining a relationship or curve between a position of the separator guide unit and a value of the second web tension, or a setting of a tension adjustment element, or a position of a tension adjustment element, or any combination thereof by comparison with a control that controls the second web tension to a desired value and comparison with a current position of the separator guide unit;
d5) maintaining a constant predetermined second web tension at different positions of the separator guide unit;
d6) position-dependent control of the second web tension with a position-controlled dancer unit;
d7) moving a dancer unit depending on a position of the separator guide unit, in such a way that the second web tension is maintained at a predetermined value;
d8) providing a deflection roller rotatably mounted at a radial distance from a center and adjusting an angular position of an axis of rotation of the deflection roller relative to a center depending on a position of the separator guide unit; and
d9) compensating for web tension fluctuations occurring during control of the second web tension.

14. A control device for a separator web feed device, wherein the control device is configured to control the separator web feed device to carry out the method according to claim 9.

15. A non-transitory computer readable medium storing a computer program comprising instructions that cause a device or apparatus to carry out the method according to claim 9 when executed by a processor.
